(19) United States
(12) Patent Application Publication
(10) Pub. No.: US 2009/0254538 A1
(43) Pub. Date: Oct. 8, 2009

(54) METHODS, SYSTEMS, AND COMPUTER PROGRAM PRODUCTS FOR SOCIAL BASED ASSISTANCE IN A SOURCE CODE CONTROL SYSTEM

(75) Inventors: Brendan Arthurs, Co. Dublin (IE); Stephen Davies, Co. Dublin (IE); Simon O'Doherty, Dublin (IE)

Correspondence Address: Cantor Colburn LLP-IBM Europe, 20 Church Street, 22nd Floor, Hartford, CT, 06103, US

(73) Assignee: INTERNATIONAL BUSINESS MACHINES CORPORATION, Armonk, NY (US)

(21) Appl. No.: 12/099,187

(22) Filed: Apr. 8, 2008

(51) Int. Cl. G06F 7/06; G06F 17/30

(52) U.S. Cl. 707/5; 707/E17.141

(57) ABSTRACT

A method, system, and computer program product for social based assistance in a source code control system are provided. The method includes selecting a segment of source code and parsing the selected segment of source code to identify one or more syntax terms. The method also includes searching source files for the one or more syntax terms to locate matching results, where the source files are managed by the source code control system. The method further includes scoring the matching results of the searching as a function of developer activity associated with the matching results. The method additionally includes identifying one or more developers with the highest degree of matching based on the scoring.

### BACKGROUND OF THE INVENTION

1. Field of Invention

The present invention relates generally to computer system source code management, and, in particular, to social based assistance for information about source code in a source code control system.

2. Description of Background

Writing code in a production level development environment can require a large number of developers working on a single product. Often developers start to implement functionality without being familiar with software components that they are calling. For example, the developers may make use of internal application program interfaces (APIs) contained within a product source tree for the product. The product source tree includes a collection of code, which may be organized hierarchically as classes and methods, and can be referenced by other classes and methods. In order to learn how to use the APIs, developers normally need to search for documentation and other references. They may also search through existing source code to look for examples to better understand how the methods work. By using logs from a source code control system employed for software release and version control, the developers can manually trace back to see who wrote the code. Further information about the original developer may then be discovered using separate resources, such as a directory system. However, sometimes the original developer identified in the logs may know a little more about the code in question but not be an expert. In other cases the developer making contact may not have a direct relationship with the person contacted, and as a result, may not get as much information from contacted party as otherwise would have been provided had the parties known each other.

Proper understanding of software components is critical when rapidly developing large programs with a minimal number of bugs. Therefore, it would be beneficial to develop a system that automates the identification of people who can help answer questions associated with existing software components. Accordingly, there is a need in the art for social based assistance for information about source code in a source code control system.

### BRIEF SUMMARY OF THE INVENTION

An exemplary embodiment is a method for social based assistance in a source code control system. The method includes selecting a segment of source code and parsing the selected segment of source code to identify one or more syntax terms. The method also includes searching source files for the one or more syntax terms to locate matching results, where the source files are managed by the source code control system. The method further includes scoring the matching results of the searching as a function of developer activity associated with the matching results. The method additionally includes identifying one or more developers with the highest degree of matching based on the scoring.

Another exemplary embodiment is a system for social based assistance in a source code control system. The system includes a source code control system to control access to source files on a data storage device, and social based assistance logic interfacing with the source code control system. The social based assistance logic performs a method that includes selecting a segment of source code and parsing the selected segment of source code to identify one or more syntax terms. The social based assistance logic further performs searching the source files for the one or more syntax terms to locate matching results, where the source files are managed by the source code control system. The social based assistance logic also performs scoring the matching results of the searching as a function of developer activity associated with the matching results. The social based assistance logic additionally performs identifying one or more developers with the highest degree of matching based on the scoring.

A further exemplary embodiment is a computer program product for social based assistance in a source code control system. The computer program product includes a storage medium readable by a processing circuit and storing instructions for execution by the processing circuit for implementing a method. The method includes selecting a segment of source code and parsing the selected segment of source code to identify one or more syntax terms. The method further includes searching source files for the one or more syntax terms to locate matching results, where the source files are managed by the source code control system. The method additionally includes scoring the matching results of the searching as a function of developer activity associated with the matching results. The method also includes identifying one or more developers with the highest degree of matching based on the scoring.

Other systems, methods, and/or computer program products according to embodiments will be or become apparent to one with skill in the art upon review of the following drawings and detailed description. It is intended that all such additional systems, methods, and/or computer program products be included within this description, be within the scope of the present invention, and be protected by the accompanying claims.

### BRIEF DESCRIPTION OF THE DRAWINGS

The subject matter which is regarded as a preferred embodiment of the present invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 depicts a system for providing social based assistance for information about source code in a source code control system in accordance with exemplary embodiments;

FIG. 2 depicts a record table set to track method usage activity in accordance with exemplary embodiments;

FIG. 3 depicts a record table set to track user usage activity in accordance with exemplary embodiments;

FIG. 4 depicts a table of user contact information in accordance with exemplary embodiments;

FIG. 5 depicts a social network diagram in accordance with exemplary embodiments; and

FIG. 6 depicts an exemplary process for providing social based assistance for information about source code in a source code control system.

The detailed description explains the preferred embodiments of the invention, together with advantages and features, by way of example with reference to the drawings.

### DETAILED DESCRIPTION OF THE INVENTION

Exemplary embodiments provide social based assistance for information about source code in a source code control system. In exemplary embodiments, social based assistance logic (SBAL) in conjunction with a source code control system (SCCS) provides information to a user identifying one or more specific developers to contact with questions regarding a selected segment of source code. The selected segment of source code can be a portion of a source file, such as a few lines, or an entire file. The source code may be in the form of a high-level language or a dynamic language (e.g., Java, C++, C#, Ruby, PHP, etc.) that can be compiled and linked into executable code or run as a script, or the source code may be low-level machine code, or anything in between. In an alternate embodiment, the source code is managed and analyzed using graphical representations of objects, components, or other building blocks.

A novice developer can enter a few lines of code relating to a specific task or function, and in response thereto the SBAL searches through a repository of source code files to identify similar source code. The SBAL may then use the SCCS to determine which developers implemented the identified source code. In an exemplary embodiment, the novice developer selects an application program interface (API) for a component to discover who has expertise with the underlying source code for the component. The list of developers identified is likely to be quite large, and as such, may not be of much use in helping the novice developer with the task of identifying a knowledgeable developer to contact further information. In order to identify the best candidates, the SBAL can order the list of developers based on one or more of the following:

Coding history—developers with more check-ins to the SCCS are likely to be more knowledgeable;

Frequency of use of the API in question by the developer;

Dates on which calls to the API were checked in—more recent check-ins indicate that the developer is more likely to remember how to use the API;

Coding similarity—if the experienced developer has worked on many of the same areas as the novice developer, the experienced developer is likely to be better able to help;

Geographic proximity—developers in the same office may be better placed to meet with the novice developer; and

Degrees of separation—referral from a third shared contact may improve the quality of the assistance provided.

Thus, the SBAL allows the novice developer to contact the best-qualified person, request an introduction, or study examples of the best-qualified person's code directly.

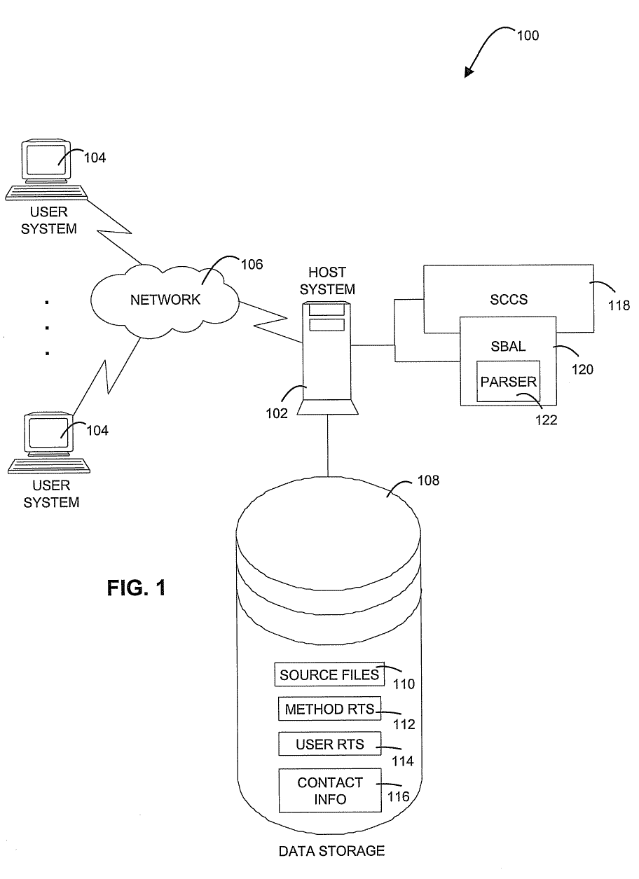

Turning now to the drawings, it will be seen that in FIG. 1 there is a block diagram of a system 100 upon which social based assistance is implemented in exemplary embodiments. The system 100 of FIG. 1 includes a host system 102 in communication with user systems 104 over a network 106. In exemplary embodiments, the host system 102 is a high-speed processing device (e.g., a mainframe computer, a desktop computer, a laptop computer, or the like) including at least one processing circuit (e.g., a CPU) capable of reading and executing instructions, and handling numerous interaction requests from the user systems 104 as a shared physical resource. The host system 102 may perform as a file server for storing and accessing files. The host system 102 can also run other applications, and may serve as a Web server, applications server, and/or a database server.

In exemplary embodiments, the user systems 104 comprise desktop, laptop, general-purpose computer devices, and/or I/O devices, such as keyboard and display devices, which provide interfaces for communicating with the host system 102. Users, such as novice developers, can initiate various tasks on the host system 102 via the user systems 104, such as accessing files or source code repositories and initiating search requests to locate an expert on a particular API.

While only a single host system 102 is shown in FIG. 1, it will be understood that multiple host systems can be implemented, each in communication with one another via direct coupling or via one or more networks. For example, multiple host systems may be interconnected through a distributed network architecture. The single host system 102 may also represent a cluster of hosts collectively performing processes as described in greater detail herein.

The network 106 may be any type of communications network known in the art. For example, the network 106 may be an intranet, extranet, or an internetwork, such as the Internet, or a combination thereof. The network 106 can include wireless, wired, and/or fiber optic links.

In exemplary embodiments, the host system 102 accesses and stores data on a data storage device 108. The data storage device 108 refers to any type of computer readable storage medium and may comprise a secondary storage element, e.g., hard disk drive (HDD), tape, or a storage subsystem that is internal or external to the host system 102. Types of data that may be stored in the data storage device 108 include, for example, various files and databases. It will be understood that the data storage device 108 shown in FIG. 1 is provided for purposes of simplification and ease of explanation and is not to be construed as limiting in scope. To the contrary, there may be multiple data storage devices 108 utilized by the host system 102.

In exemplary embodiments, the data storage device 108 includes source files 110, method record table set 112, user record table set 114, and contact information 116. The data storage device 108 may also include other types of files or data not depicted in FIG. 1. Version control for accessing the source files 110 is performed using a source code control system (SCCS) 118. Developers can check files into and out of version control using the SCCS 118, which controls permissions and updates to the source files 110. The SCCS 118 may also perform logging functions to track which users have checked in/out specific versions of files. In an exemplary embodiment, social based assistance logic (SBAL) 120 enhances information tracked by the SCCS 118 through locating code and providing users with information as to who may be an expert regarding the code beyond the initial person who checked-in the code. The SBAL 120 may also provide a user with information such as common contacts known by both the user and an identified developer, which can assist in introducing or coordinating actions between the parties. The SBAL 120 can be an independent application from the SCCS 118. Alternatively, the SBAL 120 may be incorporated in the SCCS 118 as a module, plug-in, or code segment. Additionally, the SCCS 118 and the SBAL 120 can be hosted on the host system 102, a separate system (not depicted), or a combination thereof (e.g., a distributed architecture).

An example of a user, such as a novice user, interfacing with the SBAL 120 via one of the user systems 104 is provided as follows. The user types or selects a portion of code being written or reviewed. When writing or reviewing code, the user may not fully understand the code or a method called by the code. The user activates the SBAL 120 by pressing a key or clicking on an icon to (e.g., a box indicating “social intellisense”) via the user system 104. If the user has not explicitly selected one or more lines of code via highlighting, then the current line where a cursor is positioned may be selected for analysis. The SBAL 120 utilizes parser 122 to break the selected code apart and look for core objects referenced. The parser 122 is a language specific parser, such as a Java parser, similar to that used for language compilation. The parser 122 can be directly included in the SBAL 120 or may be an external application. Moreover, multiple parsers 122 may exist to support multiple languages.

One example as to how the parser 122 operates is as follows. A selected code segment includes:

### // Code is in MyObject

SampleInterface var=SampleFactory(anotherObject) // anotherObject is of type AnotherObject.
The parser 122 breaks down the segment to isolate method calls, object references, object types, and/or comments for further analysis as core syntax terms, such as:

### MyObject

### SampleInterface

### SampleFactory

### AnotherObject

In the case of Java, these would be the main objects of interest. Other language constructs may exist for other languages. However, the parser 122 may perform syntax analysis of various types of files, e.g., PHP, Javascript, HTML, CSS, etc. The SBAL 120 looks for matches across the source files 110, which can include all files managed by the SCCS 118 at the current version. The user may also specify how many previous versions of the source files 110 are scanned. Alternatively, a defined set of the most recent revisions of the source files 110, (e.g., the last 10 revisions) can be scanned. The SBAL 120 sorts matches in order of scoring based on how many core syntax terms show up in other parts of the located source code files from the source files 110. The SBAL 120 then checks the code lines and matches the changes to people who interacted with that code section. This information may be acquired from the SCCS 118. The SBAL 120 generates a scoring based on who wrote code the most often (e.g., the most number of check-ins with changes to the code section) and returns a list to the developers with the highest degree of matching. The user has the option to contact any of the developers listed (e.g., using email, voice over Internet Protocol (VOIP), instant messaging) or can request a breakdown of an identified developer's code so as to see if it may help in understanding the code.

Using the SBAL 120 provides users with point-of-contact information beyond simply identifying the first user who checked the code into source control. This can be beneficial, especially if the person who performed the initial check-in has left the company, moved to a different project, or is not actually an expert. The SBAL 120 takes into account code written by other developers and builds a social network system on that information. As a further example, assume that Programmer 1 writes method getUserName( ) in Class GetUserDetails. Programmer 1 inserts comments in the method and has no subsequent interaction with the code. Programmer 2 writes 10-15 methods implementing the GetUserDetails class. Programmer 3 is new to the project and starts to write code. However, Programmer 3 can't get code using getUserName( ) to work. Programmer 3 highlights the code and initiates a lookup using the SBAL 120. The SBAL 120 notifies Programmer 3 that although Programmer 2 didn't write the actual class, Programmer 2 has a large amount of experience with the code. Further still, Programmer 2 may have left the project, so the SBAL 120 can find someone on the current project that can provide an introduction between Programmer 3 and Programmer 2 to assist Programmer 3 in getting more information.

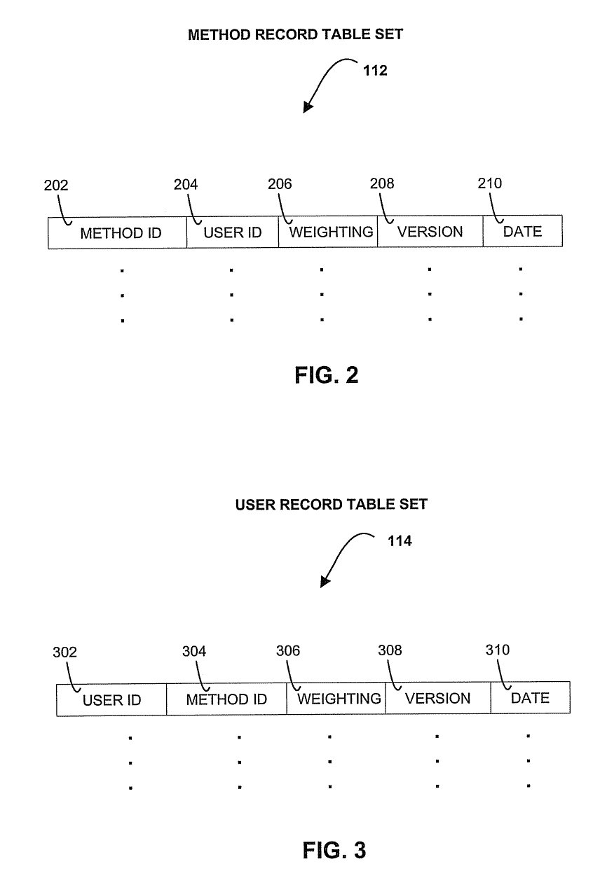

Turning now to FIG. 2, the method record table set 112 of FIG. 1 is depicted in greater detail in accordance with exemplary embodiments. The method record table set 112 tracks method usage activity, providing a source of data for the SBAL 120 to search. The method record table set 112 may represent an aggregation of multiple tables or selected fields from multiple tables. In exemplary embodiments, the method record table set 112 includes a method identifier 202, a user identifier 204, and a weighting value 206. The method record table set 112 may further include a version 208 associated with the method identifier 202 and a date 210 of the latest use of the identified method by the user. The method record table set 112 can include data for each method called as part of a common project, as well as records for all of the users of the methods. The weighting value 206 indicates overall usage of each method by each user. While referred to as “methods”, it will be understood that the disclosed structure applies to numerous organizational formats, such as classes, functions, procedures, and the like.

Turning now to FIG. 3, the user record table set 114 of FIG. 1 is depicted in greater detail in accordance with exemplary embodiments. The user record table set 114 tracks user usage activity, providing a source of data for the SBAL 120 to search. The user record table set 114 may represent an aggregation of multiple tables or selected fields from multiple tables. In exemplary embodiments, the user record table set 114 includes a user identifier 302, a method identifier 304, and a weighting value 306. The user record table set 114 may further include a version 308 associated with the method identifier 304 and a date 310 of the latest use of the identified method by the user. The user record table set 114 can include data for each method called as part of a common project, as well as records for all of the users of the methods. The weighting value 306 indicates overall usage of each method by each user. The method record table set 112 and user record table set 114 include sets of records that contain similar information, but in slightly different formats to allow for efficient usage, especially when determining the weightings required for each set of data.

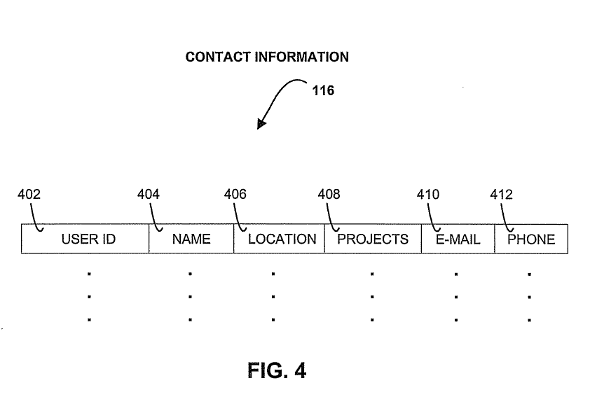

FIG. 4 depicts the contact information 116 of FIG. 1 in greater detail in accordance with exemplary embodiments. The contact information 116 may include multiple fields to locate and provide contact information for users of the SBAL 120. In an exemplary embodiment, the contact information 116 includes a user identifier 402, a name 404, a location 406, project information 408, an e-mail address 410, and a phone number 412. Other fields may also be included in the contact information 116, such as department, manager, facsimile number, cell phone number, work address, job title, level of seniority, and the like. The contact information 116 may be used by the SBAL 120 to provide users with additional information about developers or to directly initiate contact, e.g., sending an e-mail to the e-mail address 410. Information in the contact information 116 may be manually entered or automatically acquired from existing directory services. In an alternate exemplary embodiment, the contact information 116 is provided via separate directory resources (not depicted) on demand.

Returning now to FIG. 1, in one embodiment, for every change to a line of code entered in the system 100 where an API method or function is called, the SBAL 120 triggers the parser 122 to parse the line of code. The parser 122, in this case, is language specific. The result of the parsing is identification of each class and/or method involved in changes on the line of code. For Java, this includes the full class path required to identify the class without any ambiguity, e.g., “com.lotus.elearn1.module1.class1.method1” identifies “method1” in class hierarchy “com.lotus.elearn1.module1.class1”. This level of detail ensures that classes and methods with similar or identical names can be resolved properly. In addition to this, a unique method identifier can be created for each user of the SBAL 120. Once identification is completed, the SBAL 120 interrogates the method record table set 112 to see whether any method record already exists that contains the method identifier, and if none exists, it creates a new record for storing the information as described above. A method identifier, user identifier, and a weighting of 1 representing that the user has used the method once can be included in the new record. Optionally, the date of the source code change can also be stored. If a method record already exists, then the SBAL 120 determines whether the user has already made a change to the method, and if not, adds the user as a new array item again with a weighting value defined by the SBAL 120. If a method record already exists and the user has already made a change to the method, the user's weighting value may be incremented by a value defined by the SBAL 120 and the date can be optionally updated or added. A similar approach is employed for creating and updating user records in the user record table set 114.

To optionally make the SBAL 120 more efficient, only publicly available code is added to the method record table set 112 and/or the user record table set 114, i.e., code is only submitted for review by the parser 122 when it is submitted to the SCCS 118 by the developer working on it (not when the developer is working on the code in his own workspace or sandbox). In an alternate embodiment, changes to records in the method record table set 112 and/or the user record table set 114 are submitted when the code is being built, or only after each successful build. This has the advantage of making the SBAL 120 simple to implement for projects already underway by creating a new task and adding it to the overall build project being used.

When a user has a query on how a particular method is implemented, the user can initiate a search on the method in the method record table set 112. Optionally, this search application can be integrated into the developer's integrated development environment (IDE), accessible via user systems 104. The user can either view all users who have used/edited the method, or view the top 4 or 5 users of the method based on the weighting values 206 of FIG. 2. Optionally, the user can also view users based on the date 210 of last usage or combinations of any of the above depending on specific needs or preferences. If the user knows any of the developers, direct contact can be initiated via the SBAL 120.

For large and/or distributed projects, the user may not know any of the other developers listed, especially if they are working at another site. This is where the user records in the user record table set 114 can be used to determine the closeness of developers to each other with respect to the type of code they are writing by analyzing their method listings via method identifier 304 of FIG. 3. The contact information 116 can also be helpful in this regard. In exemplary embodiments, the SBAL 120 cross-references the user's own method listing against a set of other users. The set of users can be manually identified or selected automatically based on selection criteria, e.g., other users working on the same project. The SBAL 120 can assign a social number based on the number of methods that each user has in common. For example, User 1 has used method1, method 2, method 3 and method 4, and User 2 has used method1, method 4 and method 5. The SBAL 120 can determine that the Users 1 and 2 have a connection value of 2 based on the two methods they have used in common (method1 and method4). Additionally, this can also be used as a management tool to examine the developer coverage of necessary APIs being used within the project. Based on this social rating the user can then determine which other developer has the most in common with the coding experience and then approach the best other developer with any queries. Alternatively, the SBAL 120 can find experts in particular API usage and identify these developers via a search tool.

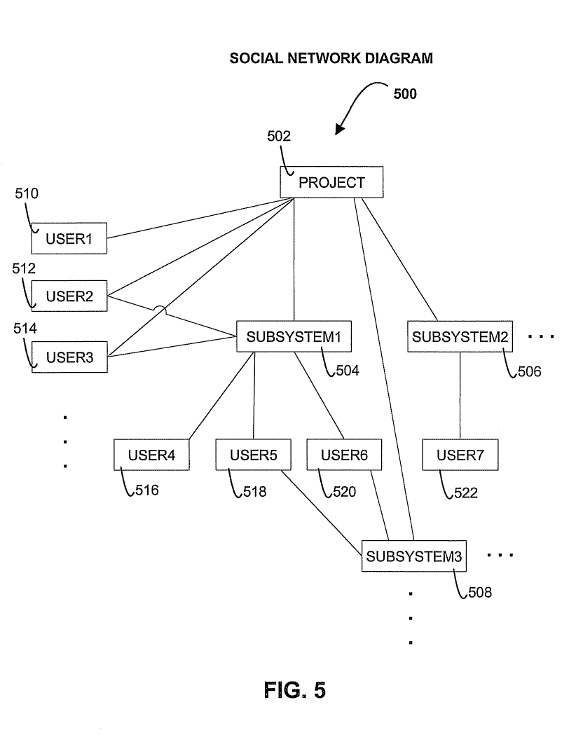

FIG. 5 depicts a social network diagram 500 in accordance with exemplary embodiments. As developers are compared against each other to determine social numbers and connectivity, the SBAL 120 of FIG. 1 can create a graphical version of connectivity as the social network diagram 500. If every developer in the system 100 is compared against every other developer in the system 100, the SBAL 120 can generate a complete social network diagram. The social network diagram 500 may be used to determine clusters of expertise and determine problem areas where developers appear to be working on subsystems in isolation to other areas of the product. The social network diagram 500 can be created for all records of a particular project, multiple projects, or a subset thereof. The social network diagram 500 is output as either graphical or text-based information.

As depicted in the example of FIG. 5, the social network diagram 500 includes project 502, subsystem1 504, subsystem2 506 and subsystem3 508. Additional subsystems not depicted may also be part of the social network diagram 500 for the project 502. User1 510, user2 512 and user3 514 are all working on the project 502 at the top-level. User2 512 and user3 514 are also working on subsystem1 504 along with user4 516, user5 518 and user6 520. User5 518 and user6 520 are also working on subsystem3 508. User7 522 is the only developer working on subsystem2 506. The social network diagram 500 may be used to determine that user7 522 can use assistance, so a manager may assign user4 516 to assist user7 522 on subsystem2 506. User4 516 can query the SBAL 120 to discover example code generated by user7 522 to assist in learning more about the subsystem2 506. As a further example, if user1 510 is assigned to help user5 518 and user6 520 in developing subsystem3 508, user1 510 can query the SBAL 120 and discover that there is a social connection between both user2 512 and user3 514 with user5 518 and user6 520, as they have collectively worked on subsystem1 504. Thus, user1 510 can leverage this information to request an introduction with user5 518 and user6 520 from either user2 512 or user3 514, since user1 510 may know user2 512 and user3 514 from work on the top-level of project 502.

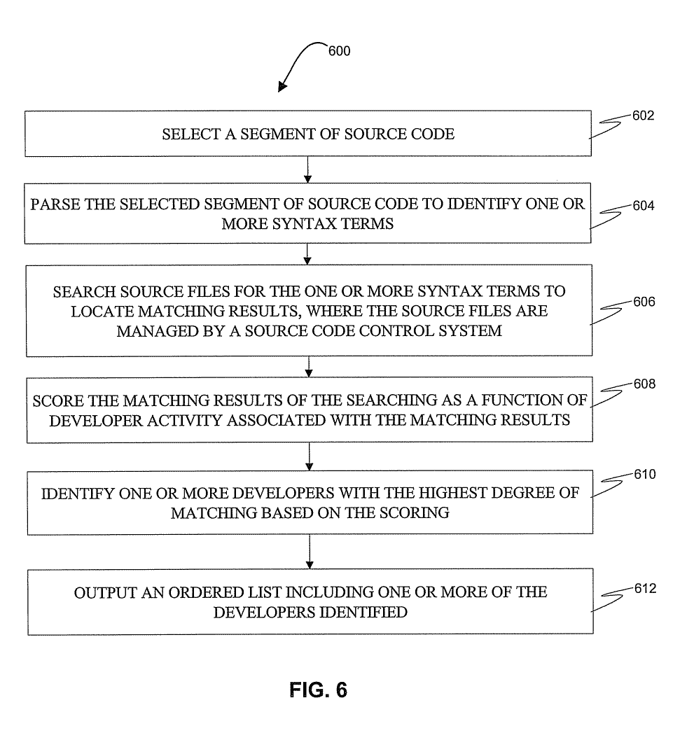

Turning now to FIG. 6, a process 600 for social based assistance in a source code control system will now be described in accordance with exemplary embodiments, and in reference to the system 100 of FIG. 1. A user, such as a novice developer, can initiate the process 600 via one of the user systems 104 to interface with the SBAL 120. At block 602, the SBAL 120 selects a segment of source code based on user input via user system 104. The selection can be typed in or graphically selected to identify the segment of source code for analysis.

At block 604, the SBAL 120 uses the parser 122 to parse the selected segment of source code to identify one or more syntax terms. The syntax terms may be identified using language specific formatting rules, allowing information such as method names, class names, object types, comments, and the like to be identified.

At block 606, the SBAL 120 searches the source files 110 for the one or more syntax terms to locate matching results, where the source files 110 are managed by the SCCS 118. The search may be initiated through the SCCS 118.

At block 608, the SBAL 120 performs scoring of the matching results of the searching as a function of developer activity associated with the matching results. The SBAL 120 can use the method record table set 112 and/or the user record table set 114 to determine information such as how frequently developers have accessed particular methods or when a source file containing the matching results was last checked-in relative to the current date. Information in the method record table set 112 and/or the user record table set 114 can also be used to calculate a social number based on a number of methods in common between a user selecting the segment of source code and the developer to determine coding similarity between the user and the developer as part of the scoring. The contact information 116 may be used to determine geographic proximity between the developers and the user of the system based on location information. Project information in the contact information 116 can be used to check for common project experience, active projects, and to assist in developing a social network diagram and calculating degrees of separation between the user selecting the segment of source code and the developer in relation to a shared contact person. Information in the method record table set 112 and/or the user record table set 114, as well as the contact information 116 can be populated and updated as the source files 110 are checked-in using the SCCS 118 and the SBAL 120.

At block 610, the SBAL 120 identifies one or more developers with the highest degree of matching based on the scoring. The identified developers can be limited to a fixed number, for instance, top-five scores, based on any number of scoring criteria previously described.

At block 612, the SBAL 120 outputs an ordered list including one or more of the developers identified. The output may be sent to user system 104 for immediate display or saved to the data storage device 108 for later use or further processing. The SBAL 120 may produce additional output, such as contact information for the one or more developers in the ordered list. Alternatively, a user may be able to directly contact developers using a contact function, such as launching an e-mail message incorporating e-mail address information from the contact information 116. A further output of the SBAL 120 may include a social network diagram, such as the social network diagram 500 of FIG. 5.

While exemplary embodiments for providing social based assistance have been described in reference to source code in a source code control system, the scope of the invention is not limited to strictly a software development environment. The term “source code” can refer to any type of design file. For example, the source code can be hardware design files written in hardware design language. The source code can be manually generated or an output of an automation tool (e.g., a files produced using a graphical code generation tool). Furthermore, the source code can be in a graphical format, where graphical components are used to develop larger models or applications.

Technical effects and benefits of exemplary embodiments include identifying the developers most likely to be of assistance in an automated way rather than through manual searches, prioritizing the list of developers likely to be of assistance, identifying shared contacts to facilitate introductions, and allowing direct access to relevant code examples rather than requiring manual searches to identify them. Providing an automated approach to identifying likely experts beyond the developer who originally checked-in source code can reduce wasted time spent by novice developers searching for assistance. The net effect on large-scale distributed development projects may be both a reduction in development time and fewer errors due to misunderstanding of the functionality and I/O requirements of various components.

As described above, embodiments can be embodied in the form of computer-implemented processes and apparatuses for practicing those processes. In exemplary embodiments, the invention is embodied in computer program code executed by one or more network elements. Embodiments include computer program code containing instructions embodied in tangible media, such as floppy diskettes, CD-ROMs, hard drives, universal serial bus (USB) flash drives, or any other computer-readable storage medium, wherein, when the computer program code is loaded into and executed by a computer, the computer becomes an apparatus for practicing the invention. Embodiments include computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

What is claimed is:

1. A method for social based assistance in a source code control system, comprising:
selecting a segment of source code;
parsing the selected segment of source code to identify one or more syntax terms;
searching source files for the one or more syntax terms to locate matching results, wherein the source files are managed by the source code control system;
scoring the matching results of the searching as a function of developer activity associated with the matching results; and
identifying one or more developers with the highest degree of matching based on the scoring.

2. The method of claim 1 further comprising the step of outputting an ordered list comprising at least one of the one or more developers identified.

3. The method of claim 1 wherein the scoring as a function of the developer activity comprises adjusting a score in response to one or more of:
a number of check-ins by the developer containing the matching results;
a frequency of use by the developer;
a last check-in date of a source file containing the matching results relative to a current date;
coding similarity between the selected segment of source code and the matching results;
geographic proximity of work location between a user selecting the segment of source code and the developer; and
degrees of separation between the user selecting the segment of source code and the developer in relation to a shared contact person.

4. The method of claim 2 further comprising:
outputting contact information for the one or more developers in the ordered list.

5. The method of claim 1 further comprising:
searching one or more of a method record table set and a user record table set to discover usage activity, wherein the method record table set comprises a method identifier, a user identifier, and a weighting value indicating overall usage of the method by the user.

6. The method of claim 5 wherein one or more of the method record table set and the user record table set are populated and updated as the source files are checked-in using the source code control system.

7. The method of claim 1 wherein the scoring further comprises calculating a social number based on a number of methods in common between a user selecting the segment of source code and the developer.

8. The method of claim 1 further comprising:
outputting a social network diagram depicting relationships between developers of the source files.

9. A system for social based assistance in a source code control system, comprising:
a source code control system to control access to source files on a data storage device; and
social based assistance logic interfacing with the source code control system, the social based assistance logic performing a method comprising:
selecting a segment of source code;
parsing the selected segment of source code to identify one or more syntax terms;
searching the source files for the one or more syntax terms to locate matching results, wherein the source files are managed by the source code control system;
scoring the matching results of the searching as a function of developer activity associated with the matching results; and
identifying one or more developers with the highest degree of matching based on the scoring.

10. The system of claim 9 further comprising outputting an ordered list including at least one of the one or more developers identified.

11. The system of claim 9 wherein the scoring as a function of the developer activity comprises adjusting a score in response to one or more of:
a number of check-ins by the developer containing the matching results;
a frequency of use by the developer;
a last check-in date of a source file containing the matching results relative to a current date;
coding similarity between the selected segment of source code and the matching results;
geographic proximity of work location between a user selecting the segment of source code and the developer; and
degrees of separation between the user selecting the segment of source code and the developer in relation to a shared contact person.

12. The system of claim 10 wherein the social based assistance logic further comprises a contact function to enable a user of the social based assistance logic to contact the one or more developers in the ordered list.

13. The system of claim 9 wherein the method performed by the social based assistance logic further comprises:
searching one or more of a method record table set and a user record table set to discover usage activity, wherein the method record table set comprises a method identifier, a user identifier, and a weighting value indicating overall usage of the method by the user.

14. The system of claim 13 wherein one or more of the method record table set and the user record table set are populated and updated as the source files are checked-in using the source code control system.

15. The system of claim 9 wherein the scoring further comprises calculating a social number based on a number of methods in common between a user selecting the segment of source code and the developer.

16. The system of claim 9 wherein the method performed by the social based assistance logic further comprises:
outputting a social network diagram depicting relationships between developers of the source files.

17. A computer program product for social based assistance in a source code control system, the computer program product comprising:
a storage medium readable by a processing circuit and storing instructions for execution by the processing circuit for implementing a method, the method comprising:
selecting a segment of source code;
parsing the selected segment of source code to identify one or more syntax terms;
searching source files for the one or more syntax terms to locate matching results, wherein the source files are managed by the source code control system;
scoring the matching results of the searching as a function of developer activity associated with the matching results;
identifying one or more developers with the highest degree of matching based on the scoring.

18. The computer program product of claim 17 further comprising:
outputting an ordered list including at least one of the one or more developers identified.

19. The computer program product of claim 17 wherein the scoring as a function of the developer activity comprises adjusting a score in response to one or more of:
a number of check-ins by the developer containing the matching results;
a frequency of use by the developer;
a last check-in date of a source file containing the matching results relative to a current date;
coding similarity between the selected segment of source code and the matching results;
geographic proximity of work location between a user selecting the segment of source code and the developer; and
degrees of separation between the user selecting the segment of source code and the developer in relation to a shared contact person.

20. The computer program product of claim 18 further comprising:
outputting contact information for the one or more developers in the ordered list.

21. The computer program product of claim 17 further comprising:
searching one or more of a method record table set and a user record table set to discover usage activity, wherein the method record table set comprises a method identifier, a user identifier, and a weighting value indicating overall usage of the method by the user.

22. The computer program product of claim 17 wherein the scoring further comprises calculating a social number based on a number of methods in common between a user selecting the segment of source code and the developer.

23. The computer program product of claim 17 further comprising:
outputting a social network diagram depicting relationships between developers of the source files.
